(19) United States
(12) Patent Application Publication
(10) Pub. No.: US 2025/0137954 A1
(43) Pub. Date: May 1, 2025

(54) System and Method for Inspection of Low Emissivity Surfaces Using a Pulsed Light Emitting Diode Heat Source for Thermal Nondestructive Evaluation

(71) Applicant: UNITED STATES OF AMERICA AS REPRESENTED BY THE ADMINISTRATOR OF NASA, WASHINGTON, DE (US)

(72) Inventor: Joseph N. Zalameda, Poquoson, VA (US)

(21) Appl. No.: 18/932,002

(22) Filed: Oct. 30, 2024

Related U.S. Application Data
(60) Provisional application No. 63/594,655, filed on Oct. 31, 2023.

(51) Int. Cl. G01N 25/72

(52) U.S. Cl. CPC G01N 25/72

(57) ABSTRACT

A system and method for thermal inspection of low emissivity or highly reflective surfaces uses a pulsed light emitting diode (PLED) heat source and optical filters for the accurate measurement of temperature on a surface to detect defects such as corrosion, cracks, pores, and dis-bonded layers. The thermal inspection system for inspecting a sample may include one or more reflector lamps including an array of light emitting diodes mounted at a base of a reflective dome; an infrared camera; and a processor for controlling the at least one reflector lamp and the infrared camera to inspect the sample. Some applications may include a manufacturing chamber for layer-by-layer manufacturing of a sample.

### CROSS-REFERENCE TO RELATED PATENT APPLICATION(S)

This application claims the benefit of and priority to U.S. provisional application 63/594,655, filed on Oct. 31, 2023, titled SYSTEM AND METHOD FOR INSPECTION OF LOW EMISSIVITY SURFACES USING A PULSED LIGHT EMITTING DIODE HEAT SOURCE FOR THERMAL NONDESTRUCTIVE EVALUATION, the contents of which are hereby incorporated by reference in its entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND

Thermal nondestructive evaluation (NDE) is commonly used for many commercial applications, and for a variety of objects, specimens, or samples (referred to as “samples” for convenience.) NDE of samples may involve the inspection of metals for corrosion, cracks, and dis-bonded layers and the inspection of composites for delamination and cracks. However it can be difficult to apply this inspection technique on unpainted surfaces with low emissivity, such as aluminum or titanium. The most common thermal inspection technique is flash thermography. Thermal inspections of a sample structure typically utilize a broad spectrum heat source, e.g., flash or quartz lamp, located on the same side as an infrared camera. The heat source provides light energy for heating the structure of the sample, while the infrared camera measures the structure's surface transient cool-down temperature response. Differences in how the structure cools down are used to detect defects; defects can change the heat flow in relative contrast to non-defective portions of the sample structure. Eq. (1) describes the relationship for light (independent of wavelength and temperature) incident on a surface. The energy is conserved, and therefore the sum of the energy reflected (r), absorbed (a), and transmitted (7) must equal 1.

$$r + a + T = 1 \qquad ( 1 )$$

If the transmission (T) is zero, the sum of the absorption and the reflectance will equal 1. For Kirchhoff's law, emissivity and absorptivity are equal therefore, a good emitter is a good absorber of energy. A high emittance or emissivity value allows for absorption of light energy to be converted to heat and allows the infrared camera to capture the emitted infrared light to measure temperature. Based on Eq. (1), with transmittance equal to zero, a low emissivity surface or highly reflective surface can be more difficult to inspect. Generally, more light is required to heat the surface, and other background light sources can interfere with the inspection imagery.

The inspection can be difficult for low emissivity surfaces for several reasons. First, the high intensity light can reflect off the surface and cause “burn-in” to the camera's detector. The “burn-in” can cause delay because it takes time for the sensors to recover, and burn-in may potentially damage the detector. Secondly, the heat source after pulsing has a transient cool down component. The cool down component can be reflected and therefore superimposed over the structure's thermal response, which can cause an error (i.e., false defect indications) in the inspection. Lastly, the heat source is spectrally broad and therefore while heating, infrared components of the heat source can produce non-uniformity in the measured temperature field.

To prevent this, typically for the inspection of low emissivity surfaces, paint or other emissivity enhancing coatings are applied before inspection. Even for painted surfaces commonly used in commercial aircraft, the coatings can be reflective in the infrared and therefore any influences from the flash lamps cooling down after firing can be detected by the infrared camera. This causes a false defect reading and can “blind” the thermal inspection from detecting true defects. Also, for graphite or fiberglass composite inspections the surface can be very smooth and reflective in the infrared band, which will again cause false indications.

Previous work has described the use of fan cooled light emitting diodes (LED) for long pulse lock-in thermography; for example, this was described in Pickering, et al., “LED optical excitation for the long pulse and lock-in thermographic techniques,” NDT and E International, vol. 58, pp. 72-77, which is incorporated herein by reference, and which showed the promise of the use of light emitting diodes. However, the cooling method was not efficient and therefore became detectable during operation. Additionally, the use of LED as a frequency modulated heat source applied to a steel sample for corrosion detection was described in Chulkov, et al., “A LED-based thermal detector of hidden corrosion flaws,” Russ J Nondestructive Test 52, 588-593 (2016), which is incorporated herein by reference. In Chulkov, an emissivity enhancing adhesive layer for detection of hidden corrosion was applied prior to detection.

There is a need in the art for a an NDE system and process that removes thermal transients not related to the inspection and produces an accurate measurement of the surface temperature for inspection of a sample.

### BRIEF SUMMARY OF THE EMBODIMENTS

In a first non-limiting embodiment, a thermal inspection system for inspecting a sample includes: at least one reflector lamp including an array of light emitting diodes (LEDs) mounted at a base of a reflective dome; an infrared (IR) camera; and a processor for controlling the at least one reflector lamp and the IR camera to inspect the sample.

In a second non-limiting embodiment, a thermal inspection system includes: a manufacturing chamber for layer-by-layer manufacturing of a sample therein; at least one reflector lamp including an array of LEDs mounted at a base of a reflective dome, the at least one reflector lamp located within the manufacturing chamber; an IR camera located outside of the manufacturing chamber, the manufacturing chamber including a viewing hole aligned with a lens of the IR camera; and a processor for controlling the at least one reflector lamp and the IR camera, wherein the at least one reflector lamp and infrared camera are located on a same side of the sample for thermal inspection.

In a third non-limiting embodiment, a method of thermally inspecting a sample includes: exposing the sample to visible light emitted from an array of LEDs mounted at a base of a reflective dome over a first predetermined window of time; receiving IR radiation generated by the sample responsive to the visible light at an IR camera over a second predetermined window of time and generating multiple thermal images of the sample therefrom; and processing the multiple generated thermal images by a processor to produce a first inspection image of the sample.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIGS. 1A, 1B, 1C and 1D illustrate pulsed light emitting diode (PLED) thermal inspection systems and features thereof in accordance with embodiments herein;

FIGS. 2A and 2B illustrate a pulsed light emitting diode (PLED) thermal inspection system and features thereof in accordance with a second embodiment herein;

FIG. 3 illustrates a pulsed light emitting diode (PLED) thermal inspection system and features thereof in accordance with a third embodiment herein;

FIGS. 4A and 4B are front and back views of a first inspection sample, an unpainted aluminum plate with backside material loss;

FIGS. 5A and 5B show results of prior art flash thermography system inspection of the first inspection sample (FIG. 5A) and results of PLED thermal inspection of the first inspection sample (FIG. 5B) in accordance with an embodiment herein;

FIGS. 6A and 6B are front and back views of a second inspection sample, an unpainted aluminum plate with circular material loss areas;

FIGS. 7A and 7B show results of prior art flash thermography system inspection of the second inspection sample (FIG. 7A) and results of PLED thermal inspection of the second inspection sample (FIG. 7B) in accordance with an embodiment herein;

FIGS. 8A, 8B and 8C illustrate a third inspection sample, a polished disk with varying processing parameters, and features thereof in accordance with an embodiment herein;

FIGS. 9A and 9B show results of prior art flash thermography system inspection of the third inspection sample (FIG. 9A) and results of PLED thermal inspection of the third inspection sample (FIG. 9B) in accordance with an embodiment herein;

FIGS. 10A and 10B show an x-ray CT image of the third inspection sample (FIG. 10A) and results of PLED thermal inspection of the third inspection sample (FIG. 10B) in accordance with an embodiment herein; and

FIG. 11 is an example curve fit of model to data for a 2.87 second heat pulse in accordance with an embodiment herein.

### DETAILED DESCRIPTION OF THE EMBODIMENTS

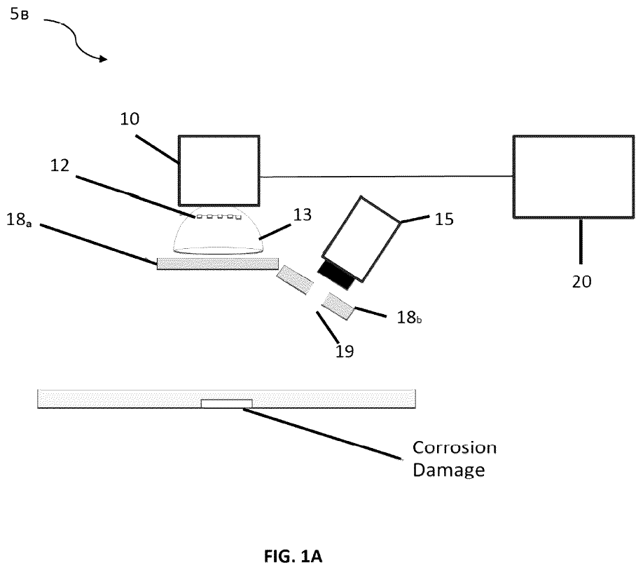

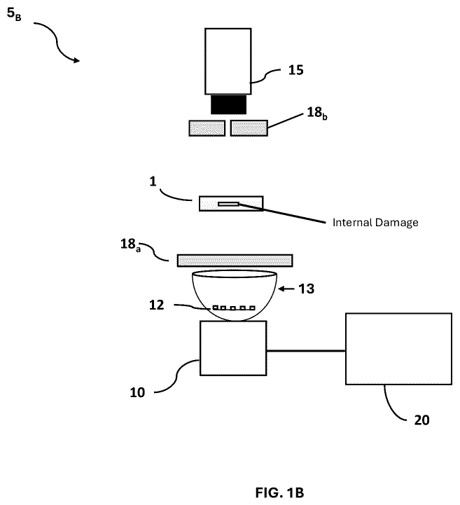

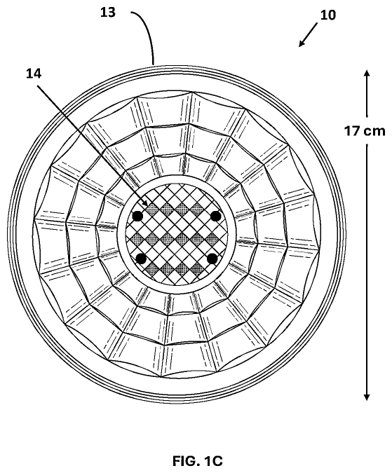

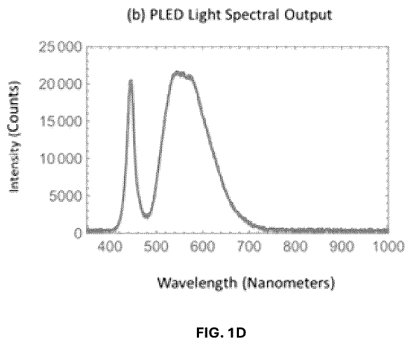

As shown in FIG. 1A, a first exemplary embodiment of a pulsed light emitting diode (PLED) thermal inspection system 5A for inspecting a sample 1, the system 5A includes a PLED lamp reflector (hereafter PLED reflector lamp) 10 which includes an array of high-powered light emitting diodes 12 (PLEDs) enclosed within reflector 13, an (infra-red) IR camera 15 and a processor 20 for image data acquisition and heat source control. In FIG. 1A, the PLED reflector lamp 10 and IR camera 15 are located on a same side of the sample 1. In FIG. 1B, the PLED reflector lamp 10 and IR camera 15 are located on opposite sides of the sample 1 in a through transmission configuration, 5_{B}.

In an exemplary embodiment, the PLED reflector lamp 10 contains an LED array 12 comprised of 14 high powered XHP70 LED chips 14 manufactured by CREE as shown in FIG. 1C mounted within reflective dome 13. The chips 14 are rated at 12 volts with a maximum current of 2.4 amps. The chips 14 are connected in parallel with two separate circuits and to a regulated power supply so the voltage and current, i.e., the amount of delivered energy, can be controlled. Each circuit is connected to a separate 240 watt regulated power supply. The lamp 10 is controlled by the processor using solid state relays. Within the lamp, the PLED array is mounted onto an aluminum heat sink plate which is placed within a flash lamp reflector. The flash lamp reflector is also covered with a clear acrylic (polycarbonate) plate (e.g., 1.27 cm thick) 18ₐ, which acts as a filter to minimize the transmission of infrared light that is produced from the heat generated by the PLED chips and associated wiring. It is advantageous to use components that do not emit thermal radiation that would be absorbed by the acrylic filter and therefore the heat sink is unanodized aluminum, mounting screws are unpainted, and the wiring does not have insulation. The PLED spectral lamp spectral light output, shown in FIG. 1D, was measured using a spectrometer with a spectral range of wavelengths of 340-1020 nanometers and as shown, the output is contained within the visible band of approximately 400 to 700 nanometers. The duty cycle of the PLED heat source is controlled by the processor. The PLED light is narrow spectrally transmitting in the visible range and therefore the polycarbonate filter does not heat. Also the filter has a low surface emissivity and therefore any absorbed light would emit minimal thermal radiation. In application, an approach or method of use of the system may involve exposing sample 1 to visible light from an array of light emitting diodes 12 over a predetermined window of time, with IR camera 15 receiving IR radiation generated by the sample 1 over a second predetermined window of time for generating multiple thermal images of the sample 1. Image data acquisition processor 20 may be used for processing the multiple generated thermal images to produce a first inspection image of the sample 1.

An exemplary IR camera 15 operates in the 3-5 micrometer IR band. One skilled in the art will appreciate that the IR camera may operate in alternative spectral bands used for temperature sensing such as near infrared or longwave infrared. The IR camera is configured with a 13, 25, or 50 mm germanium optical lenses depending on sample size. The focal plane array size of the camera was 640×512 and the camera operated at an 80 Hz frame rate. The camera frame rate was externally triggered and synchronized with the heat source. A second polycarbonate filter 18_{b} is placed in front of the IR camera 15 to block the infrared from the camera. The camera polycarbonate filter 18_{b} has a viewing hole 19 aligned with the camera lens. This blocks any infrared transmitted from the camera. Since low emissivity surfaces are being inspected, heat from the infrared camera can be seen in the acquired images if there is no filter. Also during inspection, light reflected off the inspected sample surface can add additional heat to the camera's surface which can then be detected by the infrared camera thus causing additional false indications.

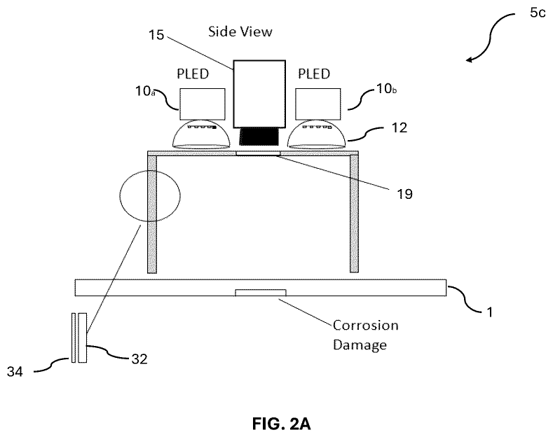

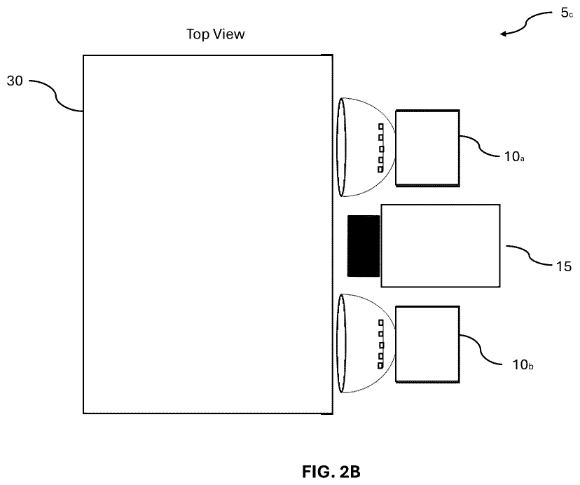

In a first alternative embodiment shown in FIGS. 2A (side view) and 2B (top view), a PLED thermal inspection system 5_{C} includes multiple PLED reflector lamps 10ₐ and 10_{b} and a thermal hood 30 wherein the light is contained within the hood 30. This provides several advantages. First the hood 30 contains the high intensity light from the PLED, secondly the hood is made of acrylic glass 32 which is in a sense the IR filter, thirdly there is a protective layer 34 outside, e.g., coated mylar, which blocks the high intensity light and protects the surfaces from contamination such as oils from finger touching or surface scratches. Note, there is an air gap between the acrylic glass 32 and protective layer 34 since, if directly contacted, the protective layer 34 would absorb the light and heat up the acrylic glass 32. Thus, in some embodiments the inner acrylic glass 32 and outer protective layer 34 may define an air gap therebetween to address this.

Surface contamination or scratches on the acrylic glass would change the optical properties and potentially reduce the transmission of the visible light and heat therefore introducing another source of infrared heat which can be superimposed over the temperature response of the sample being inspected thus causing false indications.

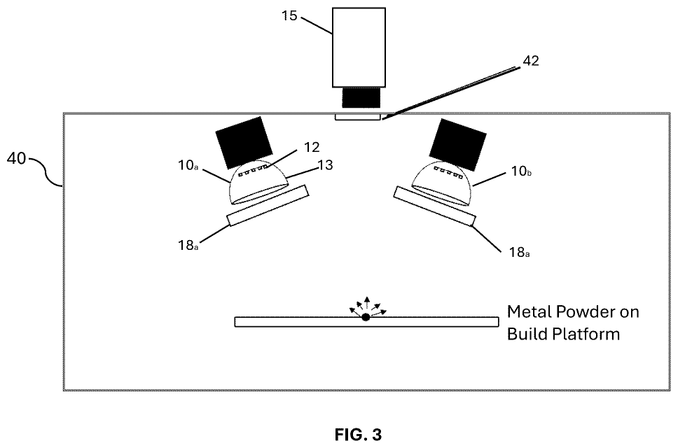

In a second alternative embodiment shown in FIG. 3, a PLED inspection system 5D includes multiple PLED reflector lamps 10ₐ and 10_{b} placed within an additive manufacturing (AM) build chamber 40 having an IR camera 15 viewing hole 42. This configuration allows for inspection of a part 1 during the build layer by layer process. Typically, metal additive manufacturing (metal AM) will have low emissivity and the PLED heat sources/reflector lamps 10ₐ and 10_{b} can be used to perform the thermal inspection after a number of layers are deposited. Since the build plate temperature increases with build time a lock-in thermography approach is employed wherein the pulsed light source is repeated at a known frequency to perform the thermal inspection. From this inspection, a volumetric inspection of the part can be performed while the part is being built. This facilitates providing volumetric inspection results along with delivery of the build part.

The PLED thermal inspection system of FIG. 1A was used to inspect various samples and the inspection results were compared to a flash thermography system. For baseline and comparison, individual emissivity of each of the 4 samples to be inspected, was measured using a technique of comparing the measured surface emissivity to a known value. The technique used a piece of black opaque electrical tape that is applied to the surface of the sample to be measured. The electrical tape emissivity is high at approximately 0.95. The surface temperature is elevated, and the emissivity is adjusted until the adjacent temperature (measured using a calibrated mid-wave infrared camera) located next to the tape is equal to the measured temperature over the tape with a known emissivity. This measurement was repeated five times to calculate an average emissivity for each sample which are shown in Table 1. The unpainted aluminum sample with material loss is highly oxidized and therefore has an emissivity of 0.35. The unpainted aluminum sample with circular material loss areas has a lower emissivity value of 0.21 which indicates the sample is more reflective. A painted aluminum sample is measured for a comparison and that value was 0.90. The polished Ti-6Al-4V disk was built using a laser powder bed fusion AM technique. The disk's emissivity value is 0.39 and is higher as compared to the aluminum samples, however these samples are low compared to a painted aluminum sample emissivity value of 0.90.

TABLE 1

| | Average Surface | Measured |
|---|---|---|
| Sample | Temperature (Celsius) | Emissivity |
| Unpainted Aluminum | 39.3 | 0.35 +/− 0.020 |
| Sample with Material | | |
| Loss | | |
| Unpainted Aluminum | 44.3 | 0.21 +/− 0.012 |
| Sample with Circular | | |
| Material Loss | | |
| Polished Additive | 65.8 | 0.39 +/− 0.017 |
| Manufactured | | |
| Ti—6Al—4V Disk | | |
| Painted Aluminum | 34.3 | 0.90 +/− 0.008 |
| Sample | | |

Unpainted Aluminum Plate with Material Loss

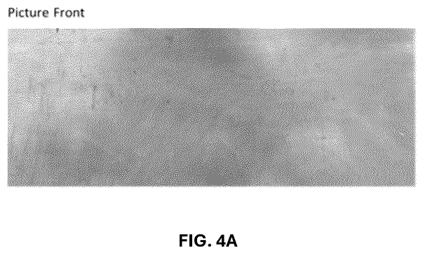

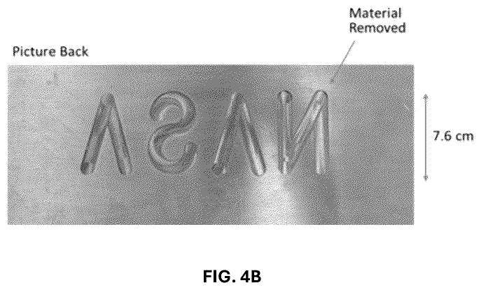

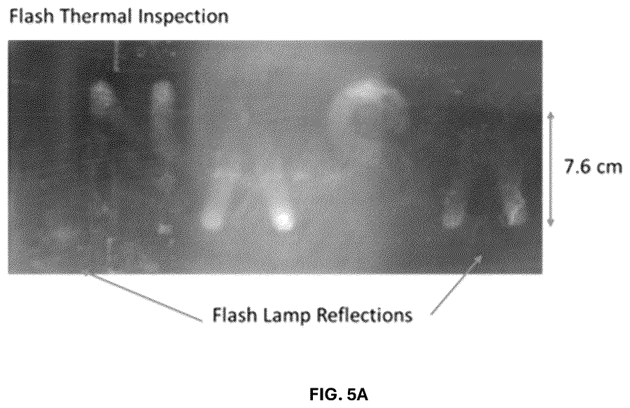

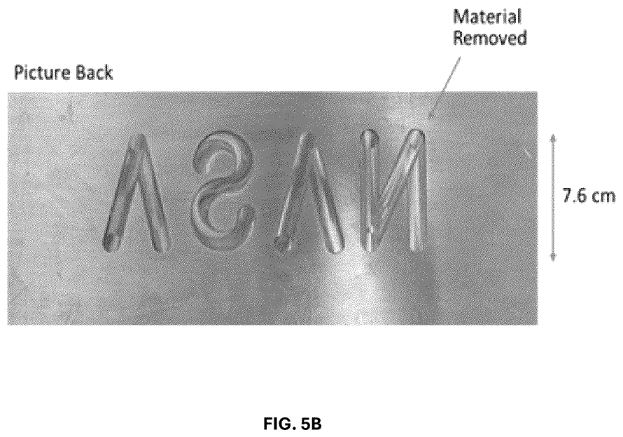

For the first sample, an unpainted aluminum plate with backside material loss was inspected using the PLED thermal system. The inspection results were compared to a flash thermography system. The unpainted aluminum plate thickness was approximately 1.63 mm thick. The material loss varied from 0.04 to 1.39 mm which represents material loss of 2.5 to 85% respectively. The front and back picture of the sample is shown in FIGS. 4A and 4B, respectively. The material loss areas form the word NASA, 45, which offers an opportunity for geometric measurement, for example. For visual comparison, FIGS. 5A and 5B are the comparison of the flash thermography system inspection of the sample, FIG. 5A, to the PLED thermal inspection of the sample, FIG. 5B. The flash data was acquired with a 640×512 mid infrared camera, with a 120 Hz frame rate, and 25 mm germanium optic. Before processing a background image (acquired before flash) was subtracted. The PLED thermal data was acquired with a 640×512 mid infrared camera, with a 100 Hz frame rate, and 25 mm germanium optic. A background image (acquired before PLED turn on) was subtracted for the frames processed.

Principal component analysis (PCA) was performed on both the PLED and flash data. This algorithm is based on decomposition of the thermal data into its principal components or eigenvectors. The PCA inspection image is calculated by dot product multiplication of the selected eigenvector times the temperature responses, pixel by pixel. The thermal inspection results were calculated using the 2^{nd} eigenvector which allowed for optimal defect contrast. The PCA time window processing for the flash data was from using images from 0.025 to 0.50 seconds. The PLED output image was obtained by PCA time window processing using images from 0.12 to 2.78 seconds. A longer time window was required, for the PLED inspection, to capture the 1 second step heat pulse and subsequent cool down. As shown in FIG. 5A, the flash thermal inspection can detect the material loss areas, however two dark bands corresponding to the linear flash tube's infrared glass filters are also detected. These flash tubes are placed behind two rectangular glass filters. Because the flash heat source is spectrally broad band, the visible light is transmitted, and the rest of the energy is absorbed. The glass filters therefore heat up thus producing a thermal transient that is superimposed over the sample's thermal response. The PLED thermal inspection image, as shown in FIG. 5B, can detect the material loss areas with no heat source reflections.

Unpainted Aluminum Plate with Circular Material Loss Areas

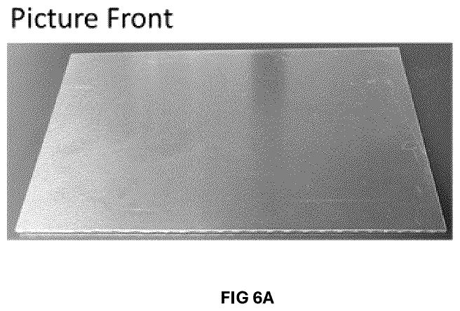

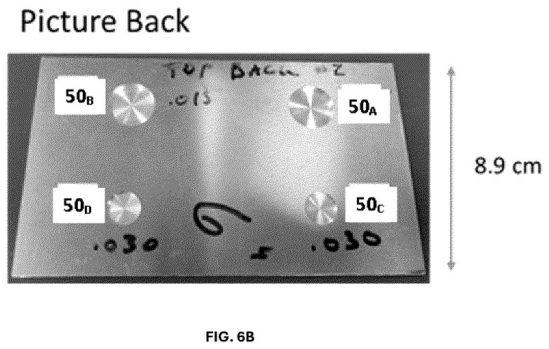

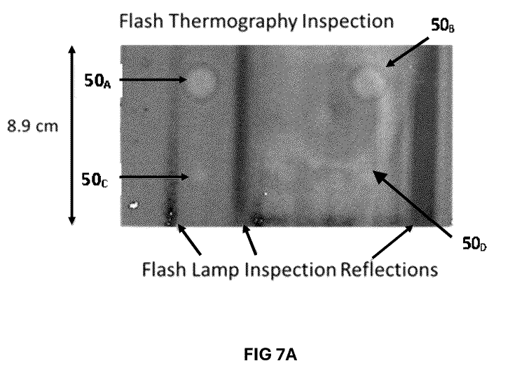

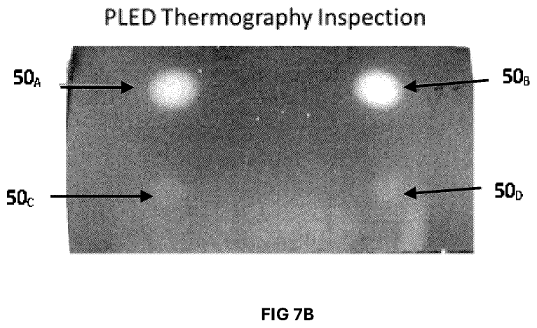

For the second sample, an unpainted aluminum plate with circular material loss defects was inspected using the PLED thermal system. The inspection results were again compared to a flash thermography inspection. The unpainted aluminum plate thickness was approximately 2.1 mm thick. The residual thicknesses of the material loss holes at the hole edges were approximately 0.38 mm for the 19.1 mm diameter holes (50_{A} and 50_{B}) and 0.76 mm for the 12.7 mm diameter holes (50_{C} and 50_{D}). It is important to note the circular hole defects are not flat bottom and therefore increases toward the center to a value of 0.46 mm and 1.0 mm for the 19.1 mm and 12.7 mm holes respectively. Front (FIG. 6A) and back (FIG. 6B) pictures of the sample are shown. FIGS. 7A and 7B shown the comparison of the flash thermography inspection, FIG. 7A, to the PLED inspection, FIG. 7B. PCA was performed on the PLED and flash data sets. The PCA time window processing for the flash data was from using images from 0.1 to 0.83 seconds. The PLED inspection image was obtained by PCA time window processing using images from 0.0625 to 6.25 seconds. A longer time window was required, for the PLED inspection, to capture the 3 second step heat pulse and subsequent cool down. As shown in FIG. 7A, the flash thermal inspection can detect all four of the material loss areas; however dark vertical bands corresponding to the flash lamp inspection are also detected. These dark bands can be attributed to the oxidized hardware with the flash hood. The PLED thermal inspection image is able to detect the material loss areas with minimal heat source reflections as shown in FIG. 7B.

Additive Manufactured Ti-6-4 Polished Disk with Varying Processing Parameters

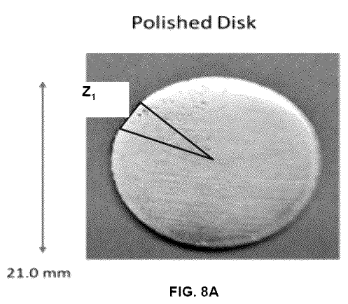

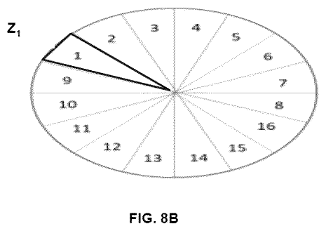

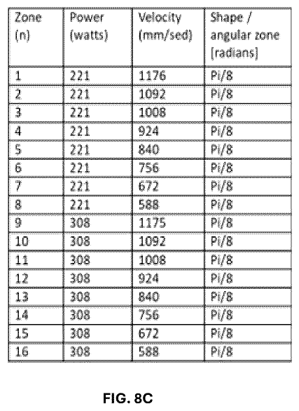

A disk sample, shown in FIG. 8A, was fabricated with a laser powder bed fusion AM technique using Ti-6Al-4V powder. The AM technique included a variety of processing parameters combined with specific angular zones 1-16 to create a wide range of localized process conditions as shown in FIG. 8B. The angular zones were built with varied laser powers and velocity combinations, as indicated in FIG. 8C. Low laser powers with fast scanning velocities resulted in low surface energy densities yielding lack of fusion porosity. A balanced combination of print parameters, power, velocity, and hatch spacing, are expected to result in fully consolidated areas. Angular zones 1-3 in the disk were printed with low surface energy densities, which results in lack of fusion porosity.

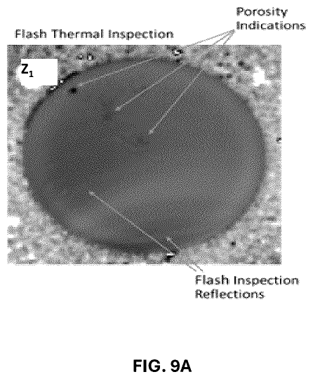

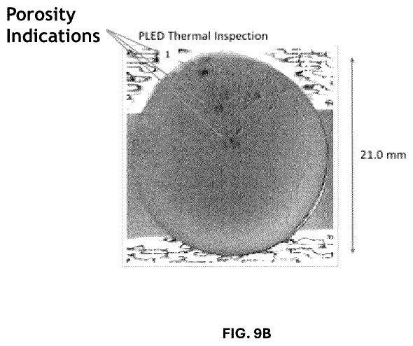

The flash and PLED thermal data were acquired with the same system described previously except that a 50 mm germanium optic was used. The PCA time window processing was from 0.167 to 0.833 seconds for the flash data. The PLED output image was obtained by PCA time window processing using images from 0.50 to 5.0 seconds. The PLED heat pulse width was set to 1 second. As shown in FIG. 9A, the flash thermal inspection can detect the porosity areas; however, light and dark bands corresponding to the flash inspection, are also evident. The PLED thermal inspection image can detect the lack of fusion porosity areas, shown as darker areas, with no heat source reflections as shown in FIG. 9B. The PLED inspection enables greater detail to be resolved.

### Comparison to X-Ray Computed Tomography (CT)

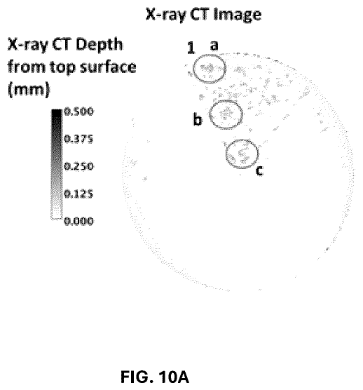

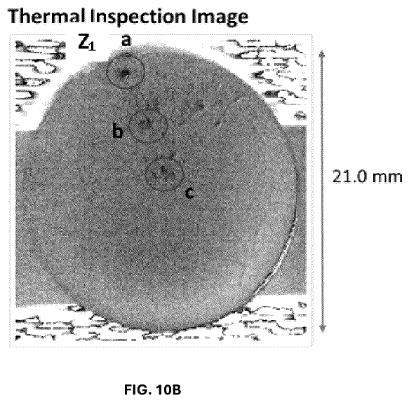

X-ray CT measurements, on the polished Ti-6Al-4V disk, were analyzed to investigate near surface porosity for comparison to the thermal inspection indications shown in FIGS. 9A 9B. The small areas a, b, and c are thermal inspection indications, shown in FIG. 10B, compare well to the X-ray CT image FIG. 10A. The X-ray CT image is processed by fitting a plane to the top surface and computing the distance to the plane for each segmented voxel corresponding to a void defect. The grey scale is then related to the void depth as shown in FIG. 10 legend. The voxel resolution of the X-ray CT was approximately 0.0127 mm for a given X, Y, Z direction. Based on these results, the thermal inspection image appears to be able to detect lack of fusion porosity from 0.125 to 0.250 mm in depth.

### Single Side Inspection Measurement for Thermal Diffusivity on Ti-6-4 Polished Disk

Single side thermography is based on the infrared camera being positioned on the same side of the heat source as shown in the setup in FIG. 1. This technique can be quantitative wherein thermal diffusivity is measured for a known thickness. An issue can be the single side thermal measurement can contain errors if any reflections are superimposed onto the samples' thermal response and this can lead to curve fitting errors where the model does not accurately represent the expected thermal response. The PLED heat source can then be advantageous for model-based quantitative single side thermal inspections. A one-dimensional thermal model with constant flux step input at x=1, is given in Eq. (2), with no flow of heat over x=0, where/is the thickness, tis time, F₀ is the input heat flux, K is the thermal conductivity, and a is the thermal diffusivity. Equation 2 is then modified to Eq. (3) to allow for pulse heating where to is input heat flux time duration produced by the PLED light.

$$T ( t , l ) = \frac{( {F}_{0} t α )}{K l} + \frac{{F}_{0} l}{K} ( \frac{1}{3} - \frac{2}{{π}^{2}} ( {\sum }_{n = 1}^{n max} \frac{- {1}^{2 n}}{{n}^{2}} {e}^{\frac{- α {n}^{2} {π}^{2} t}{{l}^{2}}} ) ) \qquad ( 2 )$$

$$T ( t , l ) = \frac{( {F}_{0} t α )}{K l} + \frac{{F}_{0} l}{K} ( \frac{1}{3} - \frac{2}{{π}^{2}} ( {\sum }_{n = 1}^{n max} \frac{- {1}^{2 n}}{{n}^{2}} {e}^{\frac{- α {n}^{2} {π}^{2} t}{{l}^{2}}} ) ) - ( \frac{( {F}_{0} ( t - {t}_{0} ) a )}{K l} + \frac{{F}_{0} l}{K} ( \frac{1}{3} - \frac{2}{{π}^{2}} ( {\sum }_{n = 1}^{n max} \frac{- {1}^{2 n}}{{n}^{2}} {e}^{\frac{- α {n}^{2} {π}^{2} ( t - {t}_{0} )}{{l}^{2}}} ) ) ) U ( t - {t}_{0} ) \qquad ( 3 )$$

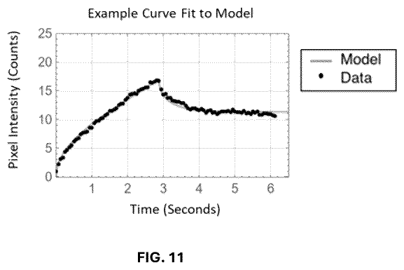

The temperature versus time curves were averaged in a 10×10 square pixel area located in the center of the polished Ti-6AL-4V disk. An example curve fit using Eq. (3) is shown in FIG. 11. The heat pulse duration was set to 3 seconds however there was a power supply lag that resulted in a heat pulse width of 2.87 seconds. This was accounted for in the model before curve fitting. The nmax was set to 30, q=F0/K, thickness 1=0.307 mm, and the curve fit was a two-parameter fit for variables q and α. The thermal data used in the fit extended out to 6 seconds and the thermal diffusivity value obtained from the fit α=0.022 cm2/sec (standard error=+/−0.0004) with q=55.0 K/cm (standard error=+/−0.7759). The literature thermal diffusivity value for solid Ti-6AL-4V (Grade 5) at room temperature is 0.029 cm2/sec. The curve fit value is less than the literature value and less than previous thermal diffusivity measurements performed using a flash through transmission technique. This could be due to the input heat flux not being truly a square pulse or the area selected may have had some deeper underlying defects. Despite these possible issues, there is good agreement between the data and the model (Eq. (3)). Thus, in application or use, the approach may include the steps of measuring thermal response from the sample 1 with the infrared camera 15 and fitting the measured thermal response with a pre-existing thermal model to determine at least one of a quantitative measurement of a material property of the sample 1 and a geometrical measurement of the sample 1.

Numerous advantages of the PLED system for inspection are summarized below.

Low emissivity surfaces can be inspected without the use of emissivity enhancing coatings such as flat black spray paint or washable paint.

Heat source is blind to camera so surface geometry reflections are greatly minimized for single sided inspection and no bright background for through transmission inspections and therefore the surface's thermal response is more accurately measured. This allows for theoretical models to be fitted to the data for quantitative measurements of material properties.

The heat source is eye safe as compared to the intense flash typically used.

There is no transient cool down heating “tail” of the PLED source as compared to the flash heat source and therefore false defect areas are not introduced. This enhances defect detection capability.

The PLED heat source does not require capacitive heavy duty power supplies and is therefore less expensive.

The PLED heat source is blind to the infrared camera so prevents potential damage to the infrared detector such as for a microbolometer infrared detector.

The heat source is spectrally narrow, contained in the visible band, and therefore heat lamp filters do not heat up and produce a thermal transients.

Certain unique features of the PLED thermal inspection system described herein are summarized below.

The system includes an array of high-powered LED lights used to heat surface for thermal inspections. The LED light is spectrally narrow band and therefore produces energy mostly in the visible band. Other heat sources used in thermal inspections use broad band light such as flash lamps and quartz lamps. The ultraviolet and infrared light is absorbed by optical filters and thereby heats up. The energy is absorbed causes the filter to heat up and cool down and this thermal transient signal can be reflected from the low emissivity surface and measured by the infrared camera.

The PLED light is carefully designed so the electrical and electronics components are low emissivity and therefore do not emit infrared radiation that could be absorbed by the acrylic filter and then re-radiate out infrared that could produce false defect indications.

Thick polycarbonate filters transmit LED visible light but block any small amount of ultraviolet and infrared.

Regulated power supply for voltage and current selection is used to control exact amount of heating and allow for comparisons to models for quantitative thermal property measurements.

Duty cycle adjustment to deliver enough energy to overcome the low surface emissivity and allow for thermal inspection.

Infrared filter over camera optics is used to block transient heating from camera due to possible reflected light energy back toward the camera or camera heating during operation.

Voltage and current can be adjusted to control the spectral output of the light to optimize surface emissivity spectral response of the surface to be inspected.

The embodiments can be applied for inspection during both manufacture and in-service of materials used in numerous industries including aerospace, automotive, power, marine, construction and oil and gas. The embodiments help ensure a product's integrity, reliability, and safety by detecting a variety of defects in the materials such as cracks, cavities, joints, inhomogeneous temperature distribution, local power loss, disbands, voids and inclusions.

This embodiment can also be used for inspection of AM build metal parts that are highly reflective.

As noted above, embodiments using the system may also extend to a method or process of thermally inspecting a sample 1 or specimen. Such a method may involve exposing a sample 1 or specimen of an article to visible light emitted from an array of LEDs 12 mounted at a base of a reflective dome 13 over a first predetermined window of time. As discussed above, one may then receive IR radiation generated by the sample that is responsive to the visible light at an IR camera 15 over a second predetermined window of time. This enables the generating of multiple thermal images of the sample 1 or specimen. One may process the multiple thermal images by a processor 20 that is specially configured to produce a first inspection image of the sample.

One may perform a step of measuring thermal response from the sample 1 with the IR camera 15, fitting the measured thermal response with a pre-existing thermal model to determine at least one of either a quantitative measurement of a material property of the sample 1 or a geometrical measurement of the sample 1. In some method embodiments, the processing may include the step of performing a principal component analysis on the multiple generated thermal images.

As with system embodiments, the method may involve visible light that is in a spectral wavelength band of approximately 400 to 700 nanometers. The IR camera 15 may operate in a spectral wavelength band of approximately 3 to 5 micrometers.

Some method embodiments may include further steps of exposing the sample 1 to visible light emitted from the array of LEDs 12 mounted at a base of a reflective dome 13 over a third predetermined window of time; receiving IR radiation generated by a sample 1 that is responsive to the visible light at an IR camera 15 over a fourth predetermined window of time and generating multiple thermal images of the sample 1 therefrom; and then processing the multiple generated thermal images by a configured processor 20 designed to produce a second inspection image of the sample 1, wherein the first and second inspection images are generated during manufacturing of the sample 1 and represent different layer combinations of the sample 1.

It is to be understood that the novel concepts described and illustrated herein may assume various alternative configurations, except where expressly specified to the contrary. It is also to be understood that the specific systems, devices and processes illustrated in the attached drawings, and described herein, are simply exemplary embodiments of the embodied concepts defined in the appended claims. Accordingly, specific dimensions and other physical characteristics relating to the embodiments disclosed herein are not to be considered as limiting, unless the claims expressly state otherwise.

Reference in the specification to “one embodiment” or to “an embodiment” means that a particular element, feature, structure, or characteristic described in connection with the embodiments is included in at least one embodiment. The appearance of the phrases “in one embodiment,” “in some embodiments,” and “in other embodiments” in the specification are not necessarily all referring to the same embodiment or the same set of embodiments.

As used herein, the terms “comprises,” “comprising,” “includes,” “including,” “has,” “having” or any other variation thereof, are intended to cover a non-exclusive inclusion. For example, a process, method, article, system or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

1. A thermal inspection system for inspecting a sample, the system comprising:
at least one reflector lamp including an array of light emitting diodes (LEDs) mounted at a base of a reflective dome;
an infrared (IR) camera; and
a processor for controlling the at least one reflector lamp and the IR camera to inspect the sample.

2. The system of claim 1, wherein the at least one reflector lamp further includes an IR filter located at an opening of the reflective dome for blocking IR radiation from exiting the reflective dome.

3. The system of claim 1, wherein the at least one reflector lamp and infrared camera are located on a same side of the sample.

4. The system of claim 1, wherein the at least one reflector lamp and infrared camera are located on opposite sides of the sample.

5. The system of claim 1, wherein the LEDs produce visible light in a spectral band of approximately 400 to 700 nanometers.

6. The system of claim 2, wherein the IR filter is formed of polycarbonate.

7. The system of claim 1, wherein the IR camera further includes an IR filter at an entrance thereof, the IR filter including a viewing hole therein aligned with a lens of the IR camera.

8. The system of claim 1, further comprising a hood which physically separates the at least one reflector lamp and the IR camera from the sample for thermal inspection, the hood including a viewing hole aligned with a lens of the IR camera.

9. The system of claim 8, wherein the hood includes an inner layer formed of acrylic glass and an outer protective layer, wherein the inner layer operates as an IR filter and further wherein inner layer and the outer protective layer define an air gap between the inner layer and the outer protective layer.

10. The system of claim 9, further comprising at least two reflector lamps.

11. A thermal inspection system for inspecting a sample, the system comprising:
a manufacturing chamber for layer-by-layer manufacturing of the sample therein;
at least one reflector lamp including an array of light emitting diodes (LEDs) mounted at a base of a reflective dome, the at least one reflector lamp located within the manufacturing chamber;
an infrared (IR) camera located outside of the manufacturing chamber, the manufacturing chamber including a viewing hole aligned with a lens of the IR camera; and
a processor for controlling the at least one reflector lamp and the IR camera, wherein the at least one reflector lamp and infrared camera are located on a same side of the sample for thermal inspection.

12. The system of claim 11, wherein each of the at least two reflector lamps further includes an IR filter located at an opening of its reflective dome for blocking IR radiation from exiting the reflective dome.

13. The system of claim 11, wherein the LEDs produce visible light in a spectral band of approximately 400 to 700 nanometers.

14. The system of claim 12, wherein the IR filter is formed of polycarbonate.

15. A method of thermally inspecting a sample, comprising:
exposing the sample to visible light emitted from an array of light emitting diodes (LEDs) mounted at a base of a reflective dome over a first predetermined window of time;
receiving infrared (IR) radiation generated by the sample responsive to the visible light at an IR camera over a second predetermined window of time and generating multiple thermal images of the sample therefrom; and
processing the multiple generated thermal images by a processor to produce a first inspection image of the sample.

16. The method of claim 15, further comprising:
measuring thermal response from the sample with the infrared camera; and
fitting the measured thermal response with a pre-existing thermal model to determine at least one of a quantitative measurement of a material property of the sample and a geometrical measurement of the sample.

17. The method of claim 15, wherein the processing includes performing principal component analysis on the multiple generated thermal images.

18. The method of claim 15, wherein the visible light is in a spectral band of approximately 400 to 700 nanometers.

19. The method of claim 15, wherein the IR camera operates in a spectral band of approximately 3 to 5 micrometers.

20. The method of claim 15, further comprising:
exposing the sample to visible light emitted from the array of light emitting diodes (LEDs) mounted at a base of a reflective dome over a third predetermined window of time;
receiving infrared (IR) radiation generated by the sample responsive to the visible light at an IR camera over a fourth predetermined window of time and generating multiple thermal images of the sample therefrom; and
processing the multiple generated thermal images by a processor to produce a second inspection image of the sample, wherein the first and second inspection images are generated during manufacturing of the sample and represent different layer combinations of the sample.
